(19) United States
(12) Patent Application Publication
(10) Pub. No.: US 2011/0254818 A1
(43) Pub. Date: Oct. 20, 2011

(54) DISPLAY

(75) Inventors: Yu-Chieh Fang, Kaohsiung City (TW); Liang-Hua Yeh, Taipei County (TW)

(73) Assignee: CHUNGHWA PICTURE TUBES, LTD., Taoyuan (TW)

(21) Appl. No.: 12/794,788

(22) Filed: Jun. 7, 2010

(30) Foreign Application Priority Data
Apr. 19, 2010 (TW) 99207072

(51) Int. Cl. G09G 5/00

(52) U.S. Cl. 345/205

(57) ABSTRACT

A display including a control circuit, a first gate driver, a second gate driver, and pixel unit groups is provided. Each pixel unit group includes a first pixel unit, a second pixel unit, a third pixel unit and a fourth pixel unit. The control circuit provides a first start signal and a second start signal to the first gate driver and the second gate driver respectively. In a first frame period, the first start signal is provided, and then after a period, the second start signal is provided to drive the first pixel unit, the second pixel unit, the third pixel unit and the fourth pixel unit sequentially. In a second frame period, the second start signal is provided, and then after a period, the first start signal is provided to drive the second pixel unit, the first pixel unit, the fourth pixel unit and the third pixel unit sequentially.

### CROSS-REFERENCE TO RELATED APPLICATION

This application claims the priority benefit of Taiwan application serial no. 99207072, filed on Apr. 19, 2010. The entirety of the above-mentioned patent application is hereby incorporated by reference herein and made a part of specification.

### BACKGROUND OF THE INVENTION

1. Field of Invention

The present invention relates to a display, and more particularly, to a display capable of eliminating zebra effect in display frames.

2. Description of Related Art

Due to rapidly advancing semiconductor technologies in the recent years, portable electronics and flat displays have also gained popularity. In various types of flat displays, liquid crystal displays (LCDs) have gradually become the main stream of display products due to features such as low operating voltage, radiation-free, light weight, compactness, and the like.

FIG. 1 schematically illustrates a conventional dual gate Z-type pixel structure. FIG. 2 is a schematic diagram showing a driving waveform and an actual waveform of a source driver in FIG. 1. Referring to FIGS. 1 and 2, the arrow represents a driving sequence of the pixels in the Z-type driving mode. As driving the pixels in a dual-gate structure by the source driver (not shown), polarities of the pixels are represented in FIG. 1.

Featured in sharing a common data line with plural pixel transistors, the dual-gate structure has much short charging time to each pixel as being driven in the Z-type driving mode. When the phase of the output of the source driver reverses, problem of insufficient charging may occur in the corresponding pixels. As shown in FIG. 2, the problem of insufficient charging forms vertical bright and dark stripes alternated with each other (so called zebra effect) in a display frame.

The zebra effect arises from the retardation of the transition of polarities of liquid crystal molecules. In the transition of polarities from positive to negative or from negative to positive, the driving signal as shown in FIG. 2 provided by the source driver is transmitted to the pixels, but however, the response time of the liquid crystal molecules is not short enough. Thus, in the dual-gate structure, only a later pixel in the same polarity with the previous one gets the target voltage.

FIG. 3 is a diagram of a start signal and clock signals according to FIG. 1. FIG. 4 is a diagram of a start signal and scan signals according to FIG. 1. Referring to FIG. 3, STVP1 represents the start signal, while CKV1 and CKVB1 represent the clock signals of shift registers CH1 through CHN. Referring to FIG. 4, the shift registers CH1 through CHN sequentially generate scan signals to scan lines G1 through GN according to the start signal STVP1. It is noted that, in FIG. 1, the sequence of the scan lines G1 through GN in receiving the scan signals is fixed. That is, the sequence is G1→G2→G3→G4 . . . . The aforementioned driving method causes the zebra effect.

### SUMMARY OF THE INVENTION

The present invention provides a display capable of eliminating the zebra effect in frame.

As embodied and broadly described herein, the present invention provides a display including a control circuit, a first gate driver, a second gate driver, a source driver and a plurality of pixel unit groups. The control circuit is adapted to generate a first start signal and a second start signal. The first gate driver is coupled to a plurality of odd-numbered scan lines and the control circuit and providing scan signals to the odd-numbered scan lines sequentially according to the first start signal. The second gate driver is coupled to a plurality of even-numbered scan lines and the control circuit and providing scan signals to the even-numbered scan lines sequentially according to the second start signal. The source driver is coupled to a plurality of data lines. Each of the pixel unit groups includes a first pixel unit, a second pixel unit, a third pixel unit and a fourth pixel unit. The first pixel unit is coupled to one of the odd-numbered scan lines. The second pixel unit is coupled to one of the even-numbered scan lines. The third pixel unit is coupled to one of the odd-numbered scan lines. The fourth pixel unit is coupled to one of the even-numbered scan lines.

According to an embodiment of the present invention, in a first frame period, the first start signal is provided, and then after a period, the second start signal is provided, so as to drive the first pixel unit, the second pixel unit, the third pixel unit and the fourth pixel unit sequentially. In a second frame period, the second start signal is provided, and then after a period, the first start signal is provided, so as to drive the second pixel unit, the first pixel unit, the fourth pixel unit and the third pixel unit sequentially. In another embodiment, the first frame period and the second frame period are alternated with each other.

In an embodiment of the present invention, the first pixel unit, the second pixel unit, the third pixel unit and the fourth pixel unit of one of the pixel unit groups are coupled to one of the data lines.

In an embodiment of the present invention, the first gate driver includes a plurality of shift registers respectively coupled to the odd-numbered scan lines and adapted to provide the scan signals to the odd-numbered scan lines sequentially according to the first start signal. In an embodiment of the present invention, the first gate driver further comprises a plurality of dummy shift registers. The dummy shift registers are respectively coupled between the shift registers to retard the transmission of the first start signal.

In an embodiment of the present invention, the second gate driver includes a plurality of shift registers respectively coupled to the even-numbered scan lines and adapted to provide the scan signals to the even-numbered scan lines sequentially according to the second start signal. In another embodiment of the present invention, the second gate driver further comprises a plurality of dummy shift registers. The dummy shift registers are respectively coupled between the shift registers to retard the transmission of the second start signal.

In light of the foregoing, the present invention is provided with a plurality of gate drivers in a display and changing the sequence of driving the pixel units by modifying the start signal of each of the gate driver. Thereby, the zebra effect in frame can be eliminated.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 schematically illustrates a conventional dual gate Z-type pixel structure.

FIG. 2 is a schematic diagram showing a driving waveform and an actual waveform of a source driver in FIG. 1.

FIG. 3 is a diagram of a start signal and clock signals according to FIG. 1.

FIG. 4 is a diagram of a start signal and scan signals according to FIG. 1.

FIG. 5 schematically illustrates a dual gate +Z/−Z type pixel structure according to a first embodiment of the present invention.

FIG. 6 is diagram illustrating a shift register according to the first embodiment of the present invention.

FIG. 7 is diagram illustrating a start signal and scan signals according to the first embodiment of the present invention.

FIG. 8 is diagram illustrating a start signal and clock signals according to the first embodiment of the present invention.

FIG. 9 is diagram illustrating a +Z/−Z driving method according to the first embodiment of the present invention.

FIG. 10 schematically illustrates a dual gate +Z/−Z type pixel structure according to a second embodiment of the present invention.

FIG. 11 is diagram illustrating a start signal and clock signals according to the second embodiment of the present invention.

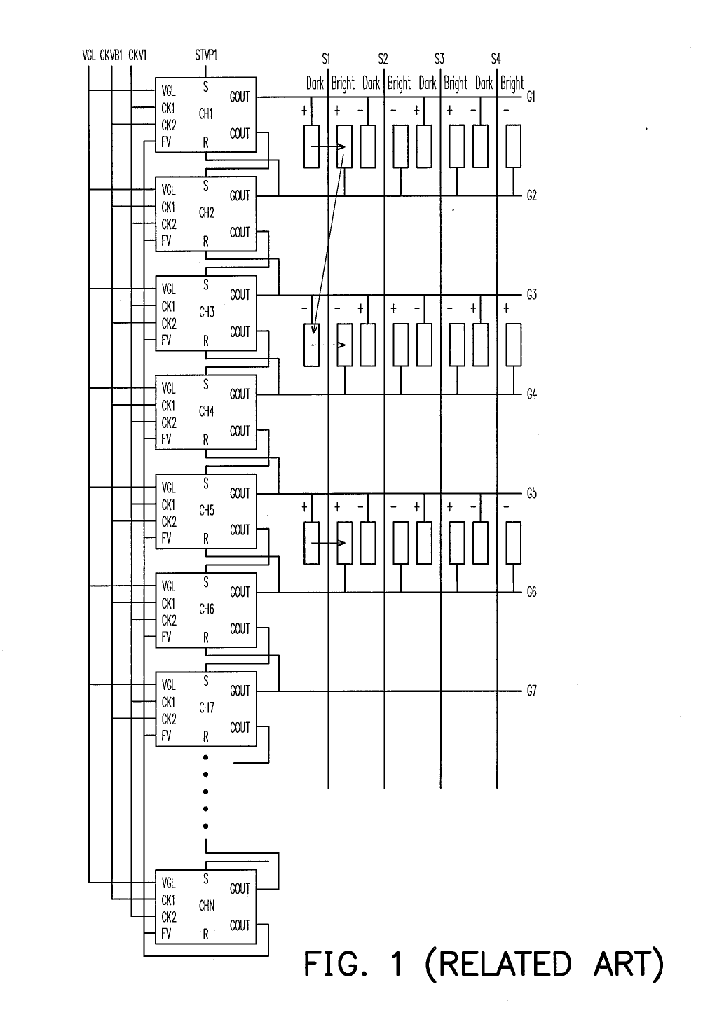

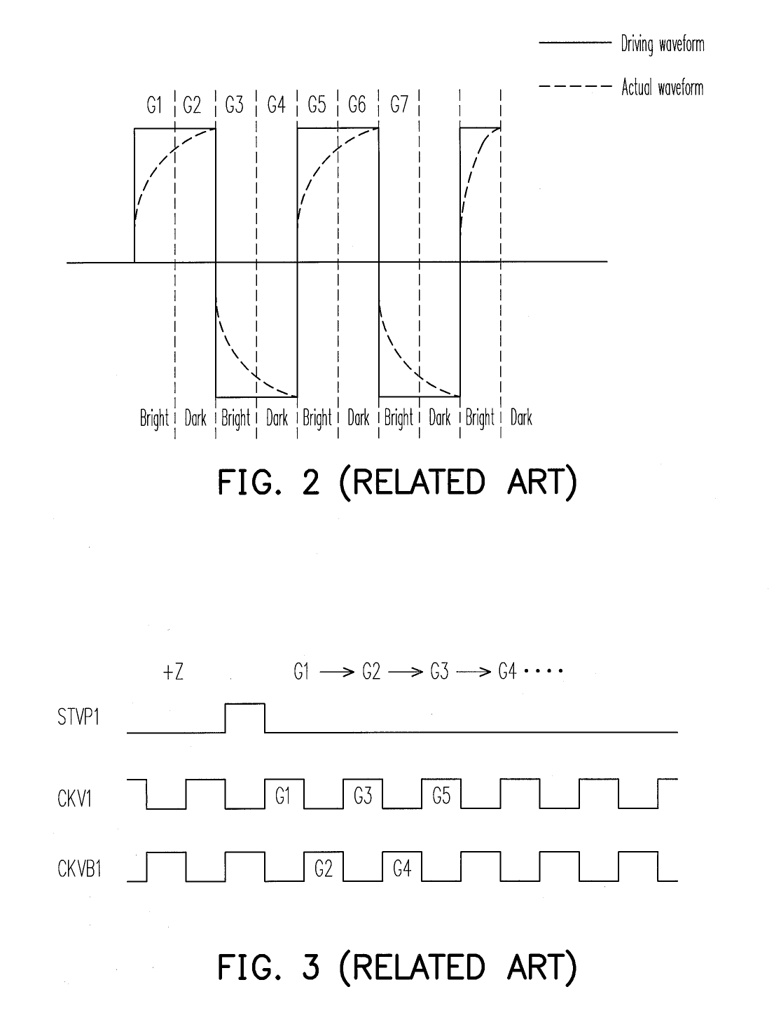

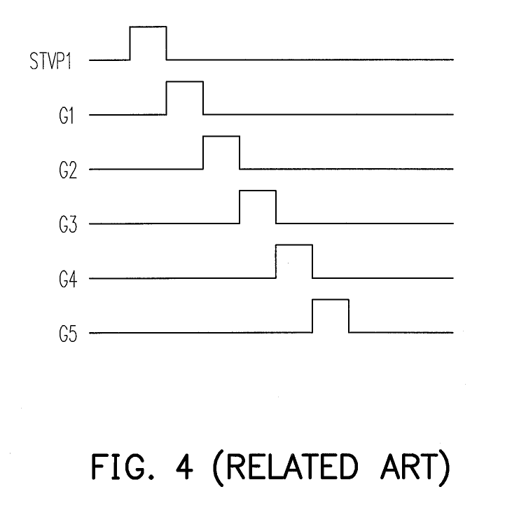

### DESCRIPTION OF EMBODIMENTS

The conventional dual-gate Z-type driving method causes the zebra effect in frame. Accordingly, the present invention provides two groups of gate drivers in a display so as to accomplish a +Z/−Z alternated driving method by modifying the sequence of the start signals of the two groups of gate drivers. Thereby, the zebra effect in frame can be eliminated. Descriptions of the invention are given below with reference to the embodiments illustrated in accompanying drawings, wherein same or similar components or steps are denoted with same reference numerals.

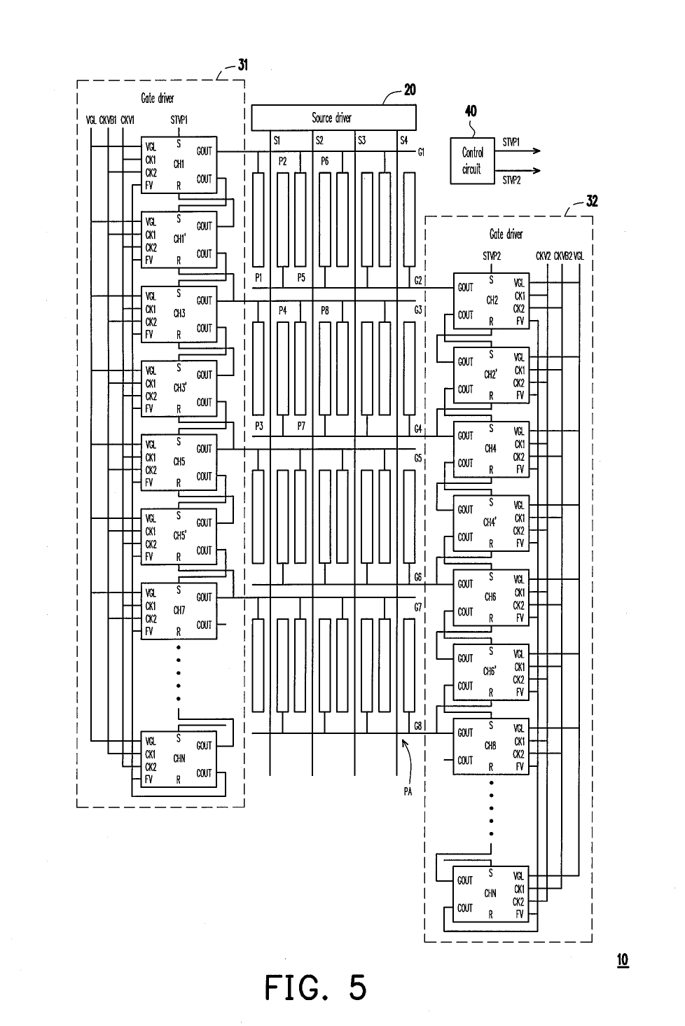

FIG. 5 schematically illustrates a dual gate +Z/−Z type pixel structure according to a first embodiment of the present invention. Referring to FIG. 5, a display 10 is taken as a liquid crystal display in the present embodiment. The display 10 includes a source driver 20, a first gate driver 31, a second gate driver 32, a control circuit 40 and a plurality of pixel unit groups, such as pixel unit group PA. The pixel unit group PA includes a plurality of pixel units, such as the pixel units P1 through P8. The first gate driver 31 includes a plurality of shift registers, such as the shift registers CH1, CH1′, CH3, CH3′, CH5, CH5′, CH7 and CH7′. The second gate driver 32 includes a plurality of shift registers, such as the shift registers CH2, CH2′, CH4, CH4′, CH6, CH6′, CH8 and CH8′. The aforementioned shift registers CH1′ through CH8′ are further called dummy shift registers.

The source driver 20 is coupled to a plurality of data lines, such as data lines S1 through S4. The pixel unit P1 is coupled to the odd-numbered scan line G1 and the data line S1. The pixel unit P2 is coupled to the even-numbered scan line G2 and the data line S1. The pixel unit P3 is coupled to the odd-numbered scan line G3 and the data line S1. The pixel unit P4 is coupled to the even-numbered scan line G4 and the data line S1. The pixel unit P5 is coupled to the odd-numbered scan line G1 and the data line S2. The pixel unit P6 is coupled to the even-numbered scan line G2 and the data line S2. The pixel unit P7 is coupled to the odd-numbered scan line G3 and the data line S2. The pixel unit P8 is coupled to the even-numbered scan line G4 and the data line S2.

The first gate driver 31 is coupled to the control circuit 40 and a plurality of odd-numbered scan lines, such as the scan lines G1, G3, G5 and G7. The first shift register 31 receives the start signal STVP1 and sequentially provides scan signals to odd-numbered scan lines G1, G3, G5 and G7 through the shift registers CH1, CH1′, CH3, CH3′, CH5, CH5′, CH7 and CH7′. In the present embodiment, the shift registers CH1, CH3, CH5 and CH7 respectively provide scan signals to the odd-numbered scan lines G1, G3, G5 and G7, while the shift registers CHF, CH3′, CH5′ and CH7′ are used to retard the transmission of the scan signals.

Similarly, the second gate driver 32 is coupled to the control circuit 40 and a plurality of even-numbered scan lines, such as the scan lines G2, G4, G6 and G8. The second shift register 32 receives the start signal STVP2 and sequentially provides scan signals to even-numbered scan lines G2, G4, G6 and G8 through the shift registers CH2, CH2′, CH4, CH4′, CH6, CH6′, CH8 and CH8′. In the present embodiment, the shift registers CH2, CH4, CH6 and CH8 respectively provide scan signals to the even-numbered scan lines G2, G4, G6 and G8, while the shift registers CH2′, CH4′, CH6′ and CH8′ are used to retard the transmission of the scan signals. An implementing structure of the shift register is given as follows for persons skilled in the art.

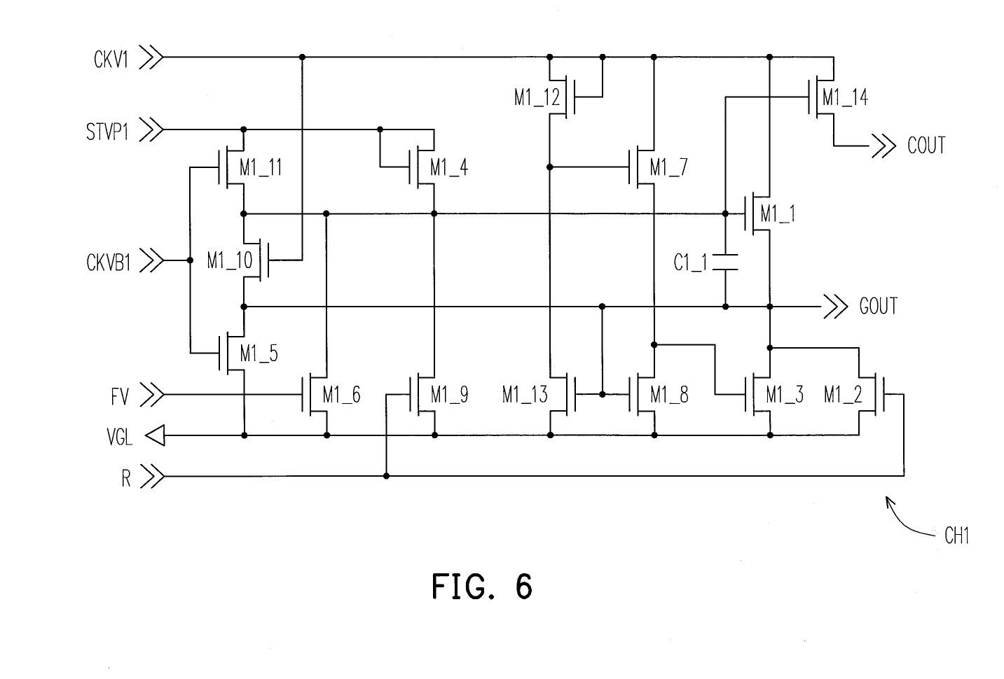

FIG. 6 is diagram illustrating a shift register according to the first embodiment of the present invention. The aforementioned shift register CH1 is illustrated in FIG. 6. The shift registers CH1 includes transistors M1_1 through M1_14 and a capacitor C1_1. The transistors M1_1 through M1_14 may be N channel transistors. However, the shift register as shown in FIG. 6 is merely an optional embodiment, while other structures of shift register may further be adopted in the present invention according to actual requirements. The implementing structure of other shift registers can be referred to the aforesaid embodiment, and is not reiterated herein.

It is noted that the Gout terminal of the shift register CHN of the last stage is not coupled to the scan line, so as to be as a reset signal of the previous stage. The Cout terminal of the shift register CHN is inputted into the Fv terminal of each stage, so as to ensure the voltage VGL being outputted to the scan line of each stage in the vertical blanking time.

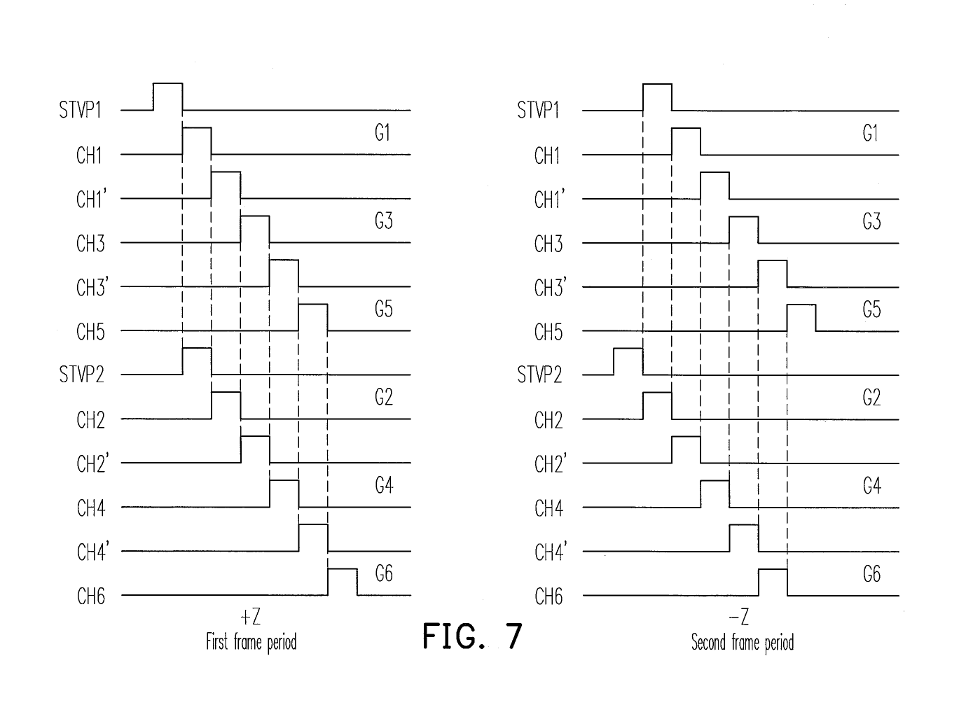

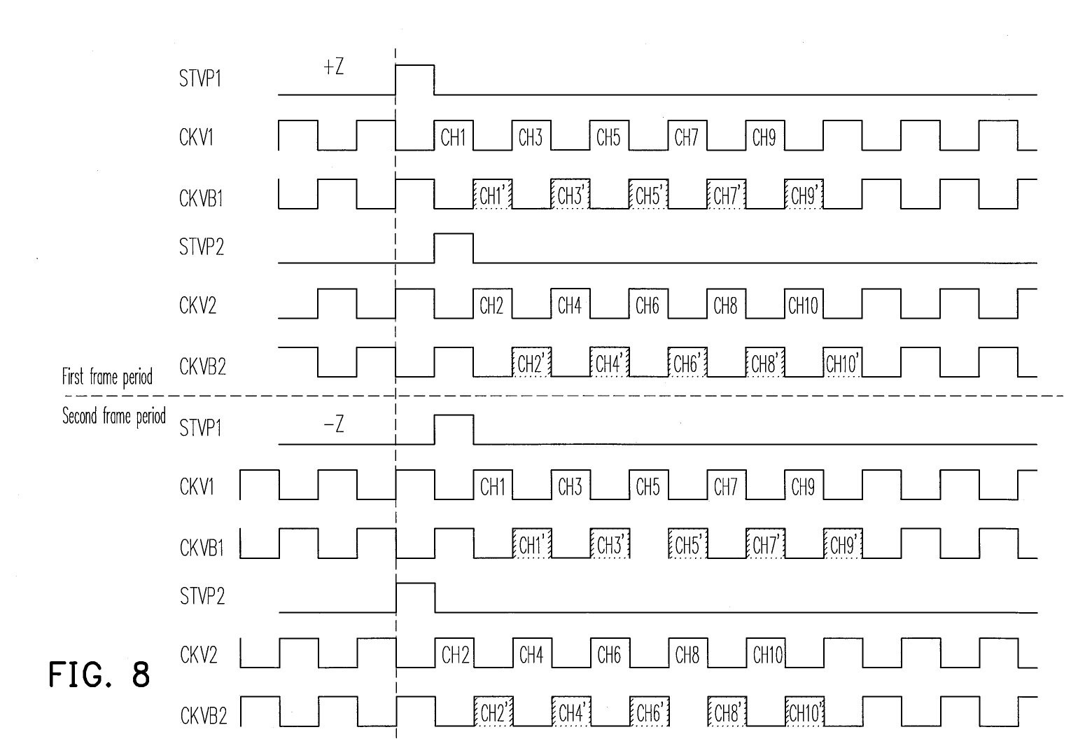

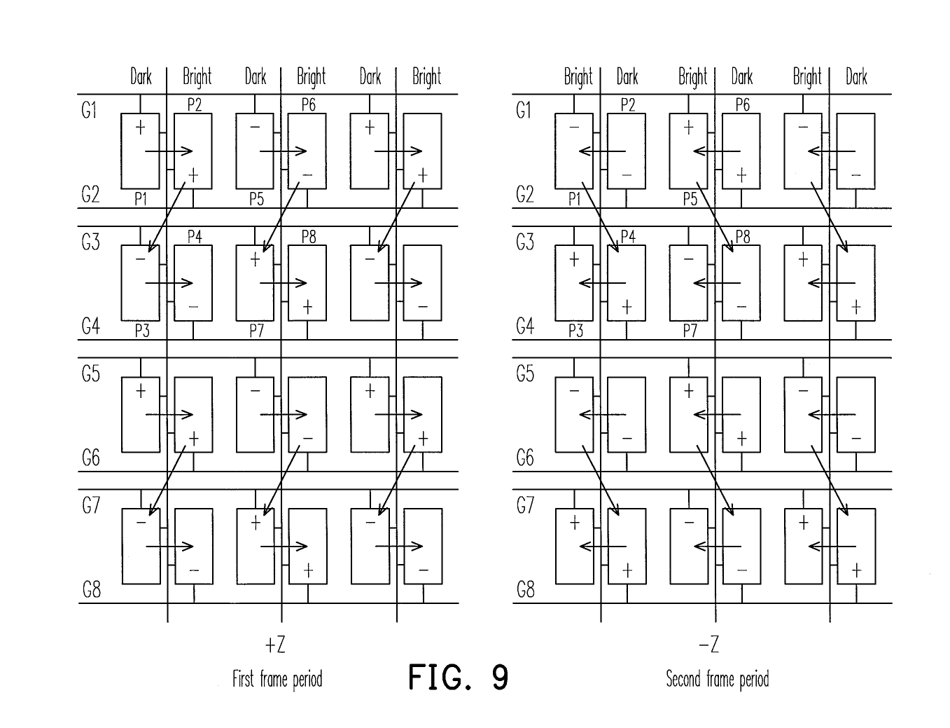

FIG. 7 is diagram illustrating a start signal and scan signals according to the first embodiment of the present invention. FIG. 8 is diagram illustrating a start signal and clock signals according to the first embodiment of the present invention. FIG. 9 is diagram illustrating a +Z/−Z driving method according to the first embodiment of the present invention. Please refer to FIG. 5 and FIGS. 7 through 9.

### DESCRIPTION OF SIGNALS

VGL: a voltage being inputted to each of the scan lines to switch off the pixel transistor of each of the pixel unit.

STVP1: a start signal of each of the shift registers in the first gate driver 31.

CKV1: one of the two clock signals in the first gate driver 31, being opposite to the clock signal CKVB1.

CKVB1: one of the two clock signals in the first gate driver 31, being opposite to the clock signal CKV1.

STVP2: a start signal of each of the shift registers in the second gate driver 32.

CKV2: one of the two clock signals in the second gate driver 32, being opposite to the clock signal CKVB2.

CKVB2: one of the two clock signals in the second gate driver 32, being opposite to the clock signal CKV2.

In the present embodiment, the first frame period, the second frame period, the third frame period, the fourth frame period . . . are continuous.

In the first frame period, the control circuit 40 provides the start signal STVP1 to the first gate driver 31, and then after a period, the control circuit 40 provides the start signal STVP2 to the second gate driver 32. The scan lines G1, G2, G3, G4, G5, G6, G7, G8 . . . receive the scan signals in sequence. The scan line G1 receives the scan signal and the pixel units P1, P5 . . . are driven. The scan line G2 receives the scan signal and the pixel units P2, P6 . . . are driven. The scan line G3 receives the scan signal and the pixel units P3, P7 . . . are driven. The scan line G4 receives the scan signal and the pixel units P4, P8 . . . are driven. Accordingly, in the first frame period, the pixel units of the pixel unit group PA are driven in +Z type driving sequence as shown by the arrows in FIG. 9.

In the second frame period, the control circuit 40 provides the start signal STVP2 to the second gate driver 32, and then after a period, the control circuit 40 provides the start signal STVP1 to the first gate driver 31. The scan lines G2, G1, G4, G3, G6, G5, G8, G7 . . . receive the scan signals in sequence. The scan line G2 receives the scan signal and the pixel units P2, P6 . . . are driven. The scan line G1 receives the scan signal and the pixel units P1, P5 . . . are driven. The scan line G4 receives the scan signal and the pixel units P4, P8 . . . are driven. The scan line G3 receives the scan signal and the pixel units P3, P7 . . . are driven. Accordingly, in the second frame period, the pixel units of the pixel unit group PA are driven in −Z type driving sequence as shown by the arrows in FIG. 9.

In such a way, the driving method of the third frame period is the same as that of the first frame period. The driving method of the fourth frame period is the same as that of the second frame period. Those are not reiterated herein.

Accordingly, the present embodiment accomplishes a +Z/−Z alternated driving method by modifying the start signals STVP1 [symbol] STVP2 in the continuous frame period. Therefore, a uniform display frame is achieved by eliminating the zebra effect.

Although the above embodiment has disclosed a possible type of a display, it is common sense to persons of ordinary knowledge in this art that different manufacturers may develop different designs of display, and the application of the present invention should not be limited to this type only. In other words, it conforms to the spirit of the present invention as long as the start signals of plural gate drivers are alternately changed to accomplish different driving method in different frame period. Another embodiment is further discussed hereinafter to allow persons skilled in the art to further comprehend and implement the present invention.

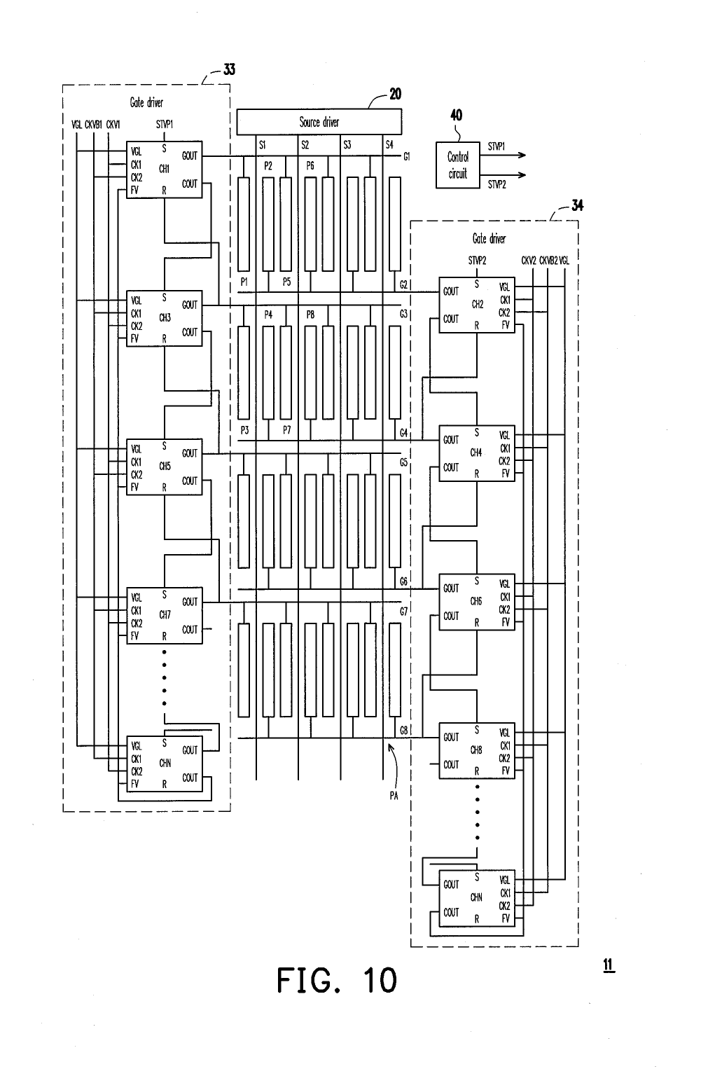

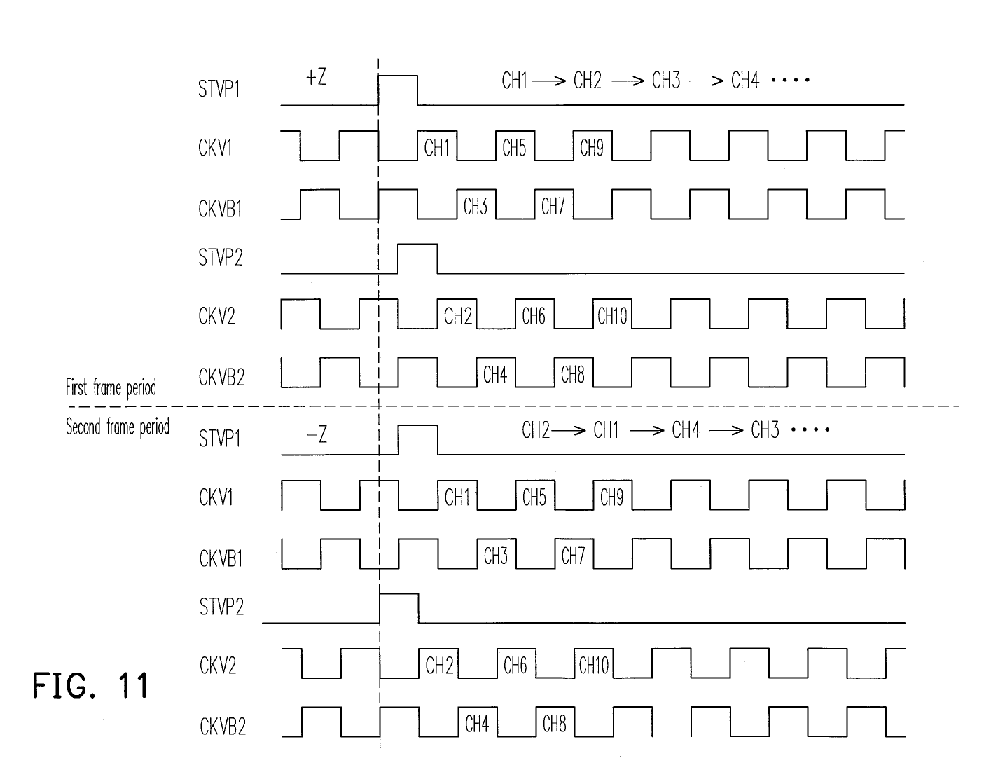

In the first embodiment, the implementing structure of the first gate driver 31 and the second gate driver 32 in FIG. 5 and the duration between the start signals STVP1 and STVP2 in FIG. 8 are merely optional embodiments and provide no limitation to the present invention. People skilled in the art are able to change the implementing manners introduced in the above embodiments based on actual demands. FIG. 10 schematically illustrates a dual gate +Z/−Z type pixel structure according to a second embodiment of the present invention. FIG. 11 is diagram illustrating a start signal and clock signals according to the second embodiment of the present invention. Referring to FIGS. 10 and 11, the display 11 of FIG. 10 is similar to the display 10 of FIG. 5 except the first gate driver 33 and the second gate driver 34 of the display 11 in FIG. 10.

In the present embodiment, the amount of the shift registers of the first gate driver 33 and the second gate driver 34 is a half of those of the first embodiment, so as to reduce the amount, the complexity and the cost of hardware. On the other hand, the first gate drivers 33 and the second gate driver 34 are respectively independent structures. The duration between the start signals STVP1 and STVP2 is shortened in the present embodiment, wherein the duration of each of the scan lines being switch on is overlapped with that of the previous scan line, such that the charging time of the pixel units is prolonged. As applying to large sized LCD panels, the pixel units can be pre-charged in the overlapped duration. Similar effects as those in the abovementioned embodiments can be achieved in this way.

In summary, the present invention is provided with a plurality of gate drivers in a display and changing the driving sequence of the pixel units by alternately modifying the sequence of the start signals in different frame periods. Thereby, the zebra effect in frame can be eliminated. Furthermore, the amount of the shift registers of the gate driver can be reduced to shorten the duration between the start signals. Therefore, the amount, the complexity and the cost of hardware can be reduced, and the charging time of the pixel unit can be increased, as being applied to large sized LCD panels.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A display, comprising:
a control circuit, generating a first start signal and a second start signal;
a first gate driver, coupled to a plurality of odd-numbered scan lines and the control circuit and providing scan signals to the odd-numbered scan lines sequentially according to the first start signal;
a second gate driver, coupled to a plurality of even-numbered scan lines and the control circuit and providing scan signals to the even-numbered scan lines sequentially according to the second start signal;
a source driver, coupled to a plurality of data lines; and
a plurality of pixel unit groups, wherein any one of the pixel groups comprises:
a first pixel unit, coupled to one of the odd-numbered scan lines;
a second pixel unit, coupled to one of the even-numbered scan lines;
a third pixel unit, coupled to one of the odd-numbered scan lines; and
a fourth pixel unit, coupled to one of the even-numbered scan lines.

2. The display as claimed in claim 1, wherein in a first frame period, the first start signal is provided, and then after a period, the second start signal is provided, so as to drive the first pixel unit, the second pixel unit, the third pixel unit and the fourth pixel unit sequentially; while in a second frame period, the second start signal is provided, and then after a period, the first start signal is provided, so as to drive the second pixel unit, the first pixel unit, the fourth pixel unit and the third pixel unit sequentially.

3. The display as claimed in claim 2, wherein the first frame period and the second frame period are alternated with each other.

4. The display as claimed in claim 1, wherein the first pixel unit, the second pixel unit, the third pixel unit and the fourth pixel unit of one of the pixel unit groups are coupled to one of the data lines.

5. The display as claimed in claim 1, wherein the first gate driver comprises a plurality of shift registers respectively coupled to the odd-numbered scan lines and adapted to provide the scan signals to the odd-numbered scan lines sequentially according to the first start signal.

6. The display as claimed in claim 5, wherein the first gate driver further comprises a plurality of dummy shift registers respectively coupled between the shift registers to retard the transmission of the first start signal.

7. The display as claimed in claim 1, wherein the second gate driver comprises a plurality of shift registers respectively coupled to the even-numbered scan lines and adapted to provide the scan signals to the odd-numbered scan lines sequentially according to the second start signal.

8. The display as claimed in claim 7, wherein the second gate driver further comprises a plurality of dummy shift registers respectively coupled between the shift registers to retard the transmission of the second start signal.
